(19) United States
(12) Patent Application Publication
(10) Pub. No.: US 2016/0011791 A1
(43) Pub. Date: Jan. 14, 2016

(54) STORAGE CONTROL APPARATUS, STORAGE SYSTEM, AND PROGRAM

(71) Applicant: FUJITSU LIMITED, Kawasaki-shi (JP)

(72) Inventor: Kenji SAWADA, Kawasaki (JP)

(73) Assignee: FUJITSU LIMITED, Kawasaki-shi (JP)

(21) Appl. No.: 14/742,104

(22) Filed: Jun. 17, 2015

(30) Foreign Application Priority Data
Jul. 8, 2014 (JP) 2014-140732

(51) Int. Cl. G06F 3/06

(52) U.S. Cl. CPC G06F 3/0611; G06F 3/0659; G06F 3/067

(57) ABSTRACT

A storage control apparatus in a storage system including a plurality of nodes each including a storage apparatus that stores data and the storage control apparatus that controls processing of the data in the storage apparatus, the storage control apparatus includes: a communication unit configured to communicate with a higher-level apparatus that instructs processing of the data in the storage apparatus and with the storage control apparatus included in another node; and a control unit configured to control the communication unit so that a command is transmitted to the storage control apparatuses included in all the other nodes when the communication unit receives the command from the higher-level apparatus, the command including an instruction about processing of data in the storage apparatus included in an arbitrary node.

### CROSS-REFERENCE TO RELATED APPLICATIONS

This application is based upon and claims the benefit of priority of the prior Japanese Patent Application No. 2014-140732, filed on Jul. 8, 2014, the entire contents of which are incorporated herein by reference.

### FIELD

The embodiments discussed herein are related to a storage control apparatus, a storage system, and a program.

### BACKGROUND

Redundant Arrays of Inexpensive Disks (RAID) apparatuses capable of realizing high reliability and high reading-writing performance are used in systems that process large volume data. The RAID apparatuses are apparatuses in which multiple storage units, such as hard disk drives (HDDs), are connected to each other for redundancy. In addition, Network Attached Storage (NAS) apparatuses may be used in which a mechanism that is accessible from multiple host apparatuses via a network is provided for centralized control of data. A storage apparatus which includes one RAID apparatus or in which multiple RAID apparatuses are combined is hereinafter referred to as a disk array.

A process of writing data into the disk array and a process of reading out data from the disk array are controlled by a control unit called a controller. Accordingly, each host apparatus performs reading and writing of data from and into the disk array via the controller. A pair of one controller and a disk array controlled by the controller may be managed in units of nodes. In each storage system including multiple nodes, the nodes are connected via the network and a mechanism to transfer a writing request or a reading request of data, which a node has received from the host apparatus, to another node is provided.

In the storage system described above, a high-speed cache memory may be provided in the controller in order to increase a response speed to the host apparatus. In this case, upon reception of the writing request into the disk array from the host apparatus, after storing writing data in the cache memory, the controller notifies the host apparatus of completion of the writing. Then, the controller stores the writing data stored in the cache memory in the disk array. With this mechanism, it is possible to quickly notify the host apparatus of the completion of the writing. Also in reading out of data, if the target data is stored in the cache memory, it is possible to read out the data from the cache memory to quickly transfer the data to the host apparatus.

For example, Japanese Laid-open Patent Publication No. 2005-157815 discloses a storage system which includes multiple channel adapters communicating with a host apparatus, multiple storage adapters communicating with a storage device, and a main cache memory to increase the response speed to the host apparatus. In such a storage system, pieces of data transmitted and received between the channel adapter and the storage adapter are stored in the main cache memory. The channel adapter includes a local cache memory. The channel adapter duplicates writing data and writes the duplicated writing data into the local cache memory in response to a writing request and transmits a completion notification to the host apparatus.

The channel adapter collectively transfers the pieces of writing data stored in the local cache memory to the main cache memory asynchronously with the completion notification. In addition, the channel adapter manages directory information on the data stored in the local cache memory and, upon reception of a reading request, searches for the reading data in the local cache memory using the directory information. When the reading data is found, the channel adapter transfers the reading data from the local cache memory to the host apparatus.

For example, Japanese Laid-open Patent Publication No. 2000-259502 discloses a data processing system which includes a calculation node, a first input-output (I/O) node, and a second I/O node to increase the efficiency of writing of data. In the data processing system, the first I/O node, which has received a writing request from the calculation node, transfers writing data to the second I/O node. The second I/O node, which has received the writing data, transmits a confirmation message to the calculation node after receiving the writing data. At this time, after writing the writing data into a non-volatile storage in the first I/O node, the first I/O node submits a deletion request to delete the writing data from a volatile memory in the second I/O node to the second I/O node.

In the case of the storage system including multiple nodes, commands issued by the host apparatus may not be directly transmitted to nodes where processing is to be performed and which are specified in the commands. For example, a command issued by the host apparatus is transmitted to a node that is determined at random. Accordingly, the process of transferring the command described above is caused. In transfer of a command which a node has received from the host apparatus to another node, a process is caused in which the node which has received the command from the host apparatus analyzes the command to determine the destination of the transfer. Omission of this process may contribute a reduction in the transfer time.

### SUMMARY

According to an aspect of the invention, in a storage system including a plurality of nodes each including a storage apparatus that stores data and a storage control apparatus that controls processing of the data in the storage apparatus, the storage control apparatus includes: a communication unit configured to communicate with a higher-level apparatus that instructs processing of the data in the storage apparatus and with the storage control apparatus included in another node; and a control unit configured to control the communication unit so that a command is transmitted to the storage control apparatuses included in all the other nodes when the communication unit receives the command from the higher-level apparatus, the command including an instruction about processing of data in the storage apparatus included in an arbitrary node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary storage system according to a first embodiment;

FIG. 2 illustrates an exemplary storage system according to a second embodiment;

FIG. 3 illustrates exemplary hardware capable of realizing the function of a host computer according to the second embodiment;

FIG. 4 illustrates exemplary hardware capable of realizing the functions of a controller and a storage according to the second embodiment;

FIG. 5 is a sequence diagram illustrating an exemplary process performed by the controller in response to a write command;

FIG. 6 illustrates an exemplary command;

FIG. 7 is a sequence diagram illustrating an exemplary process (when data exists in a save area) performed by the controller in response to a read command;

FIG. 8 is a sequence diagram illustrating an exemplary process (when data does not exist in the save area) performed by the controller in response to the read command;

FIG. 9 is a sequence diagram illustrating an exemplary process (a process including transfer of a command) performed by the controller in response to the write command;

FIG. 10 is a sequence diagram illustrating an exemplary process (a process including the transfer of a command: when data exists in the save area) performed by the controller in response to the read command;

FIG. 11 is a sequence diagram illustrating an exemplary process (a process including the transfer of a command: when data does not exist in the save area) performed by the controller in response to the read command;

FIG. 12 is a sequence diagram illustrating an exemplary process performed by the controller according to the second embodiment in response to a command;

FIG. 13 illustrates exemplary management information according to the second embodiment;

FIG. 14 is a first diagram for describing an exemplary method of updating the management information according to the second embodiment;

FIG. 15 is a second diagram for describing an exemplary method of updating the management information according to the second embodiment;

FIG. 16 is a third diagram for describing an exemplary method of updating the management information according to the second embodiment;

FIG. 17 is a fourth diagram for describing an exemplary method of updating the management information according to the second embodiment;

FIG. 18 is a flowchart illustrating an exemplary process performed by a controller in a first node according to the second embodiment in response to the write command;

FIG. 19 is a flowchart illustrating an exemplary process performed by a controller in a second node according to the second embodiment in response to the write command;

FIG. 20 is a flowchart illustrating an exemplary process performed by a controller in a third node according to the second embodiment in response to the write command;

FIG. 21 is a flowchart illustrating an exemplary process performed by the controller in the first node according to the second embodiment in response to the read command; and

FIG. 22 is a flowchart illustrating an exemplary process performed by the controller in the second node according to the second embodiment in response to the read command.

### DESCRIPTION OF EMBODIMENTS

Embodiments of the present disclosure will herein be described with reference to the attached drawings. The same reference numerals are used in the specification and the drawings to identify the components having substantially the same functions. A duplicated description of such components may be omitted herein.

### First Embodiment

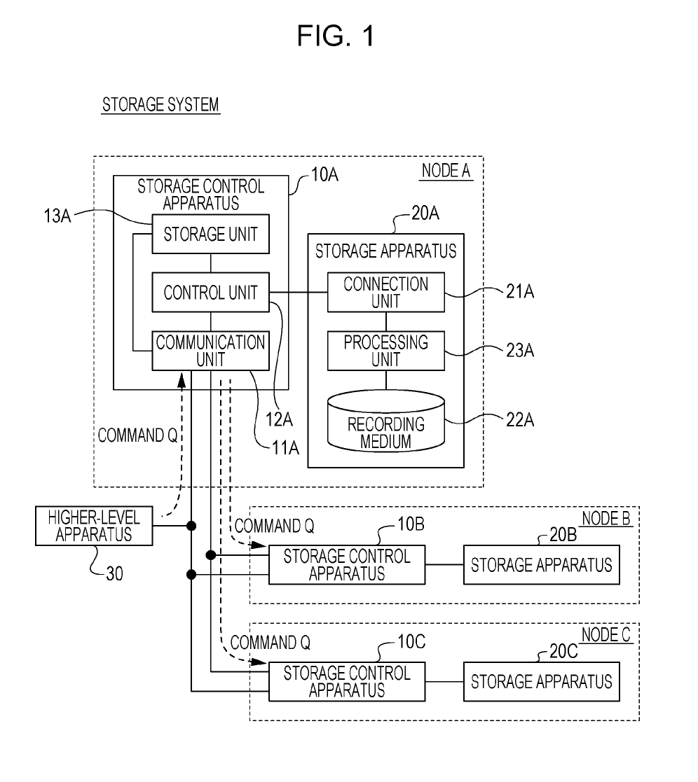

A first embodiment will now be described with reference to FIG. 1. FIG. 1 illustrates an exemplary storage system according to the first embodiment.

The storage system illustrated in FIG. 1 includes nodes A, B, and C.

In the example in FIG. 1, the node A includes a storage apparatus 20A that stores data and a storage control apparatus 10A that controls processing of the data in the storage apparatus 20A. The node B includes a storage apparatus 20B that stores data and a storage control apparatus 10B that controls processing of the data in the storage apparatus 20B. The node C includes a storage apparatus 20C that stores data and a storage control apparatus 10C that controls processing of the data in the storage apparatus 20C.

One or more of storage apparatuses may be included in one node. One or more of storage control apparatuses may be included in one node. Although one storage apparatus and one storage control apparatus compose a unit of hardware in each node in the example in FIG. 1, the nodes may be set in another mode.

For example, the nodes may be set in units of one or more logical storage areas that are set in one or more storage media in the storage apparatus or may be set in units of one or more logical arithmetic resources that are set in one or more processors in the storage control apparatus. In addition, when a technology to virtualize the hardware is applied to operate two storage control apparatuses as three or more virtual storage control apparatuses, the nodes may be set in units of the virtual storage control apparatuses. Similarly, virtualization of the storage apparatuses may be available. However, the description is presented based on the example in FIG. 1 for simplicity.

The storage control apparatus 10A includes a communication unit 11A, a control unit 12A, and a storage unit 13A. The storage apparatus 20A includes a connection unit 21A, a recording medium 22A, and a processing unit 23A. A higher-level apparatus 30 instructs processing of data in the storage apparatuses 20A, 20B, and 20C. The higher-level apparatus 30 is an example of a computer (an information processing apparatus) typified by a server apparatus, a terminal apparatus, or the like.

The storage unit 13A is a volatile storage unit, such as a random access memory (RAM), or a non-volatile storage unit, such as an HDD or a flash memory. Each of the control unit 12A and the processing unit 23A is a processor, such as a central processing unit (CPU) or a digital signal processor (DSP). However, each of the control unit 12A and the processing unit 23A may be an electronic circuit, such as an application specific integrated circuit (ASIC) or a field programmable gate array (FPGA). The control unit 12A executes a program stored in, for example, the storage unit 13A or another memory. The processing unit 23A executes a program stored in, for example, the recording medium 22A or another memory.

The communication unit 11A communicates with the storage control apparatus 10B and the storage control apparatus 10C included in the other nodes B and C, respectively. For example, the communication unit 11A receives a command Q from the higher-level apparatus 30. The command Q includes an instruction about the processing of the data in each of the storage apparatuses 20A, 20B, and 20C included in the arbitrary nodes A, B, and C, respectively. In this case, the control unit 12A controls the communication unit 11A so that the command Q is transmitted to the storage control apparatus 10B and the storage control apparatus 10C included in all the other nodes: the node B and the node C, respectively. The storage unit 13A is a component that temporarily stores data. In the case of a write command, a writing instruction and data to be written compose the write command.

The connection unit 21A is a component that connects the storage apparatus 20A to the storage control apparatus 10A. The recording medium 22A is a component that stores data. The recording medium 22A is, for example, one or more HDDs, one or more solid state drives (SSDs), or a RAID apparatus. The processing unit 23A performs a process of writing data into the recording medium 22A or a process of reading out data from the recording medium 22A under the control of the storage apparatus 20A.

The communication unit 11A may receive the command Q including an instruction about the writing process of data in the storage apparatuses 20A, 20B, and 20C included in the arbitrary nodes A, B, and C, respectively, and the data from the storage control apparatuses 10B and 10C included in the other nodes B and C, respectively. In this case, the control unit 12A stores the command Q received by the communication unit 11A in the storage unit 13A.

In addition, the communication unit 11A may receive the command Q including an instruction about the reading process of data in the storage apparatuses 20B and 20C included in the other nodes B and C, respectively. In this case, when the data which is the target of the instruction is stored in the storage unit 13A, the control unit 12A controls the communication unit 11A so that the data is read out from the storage unit 13A and is transmitted to the higher-level apparatus 30.

As described above, the communication unit 11A may receive the command Q including the instruction about the writing process of data in the storage apparatus 20A included in the node A and the data from the higher-level apparatus 30. In this case, the control unit 12A controls the communication unit 11A so that the command Q is stored in the storage unit 13A and a response to the command Q is transmitted to the higher-level apparatus 30. The control unit 12A stores the data in the storage apparatus 20A after transmitting the response. At this time, the control unit 12A controls the communication unit 11A so that a completion notification indicating completion of the storage of the data in the storage apparatus 20A is transmitted to the storage control apparatuses 10B and 10C included in all the other nodes: the nodes B and C, respectively.

The communication unit 11A may receive a completion notification indicating completion of the storage of the data in the storage apparatuses 20B and 20C included the other nodes B and C from the storage control apparatuses 10B and 20C included in the other nodes B and C, respectively. In this case, the control unit 12A deletes the same data as the data stored in the storage apparatuses 20B and 20C from the storage unit 13A. The data may be deleted a predetermined time after the data is stored in the storage unit 13A.

The transfer of the command Q received by the storage control apparatus 10A in the node A to all the storage control apparatuses 10B and 10C included in the other nodes B and C in the above manner allows a process of analyzing the command in the transfer to select the destination of the transfer to be omitted. As a result, it is possible to speed up the transfer process of the command Q. In addition, the storage of the data in the command Q in the storage control apparatuses 10A, 10B, and 10C allows the storage control apparatus having a higher response speed to quickly respond to a reading request.

For example, when the reading request is submitted to the storage control apparatus that is performing the writing process, the response from another storage control apparatus to the higher-level apparatus 30 enables the quick response. Although only one higher-level apparatus 30 is illustrated in the example in FIG. 1 for convenience, multiple higher-level apparatuses may be provided in the storage system. When multiple higher-level apparatuses are included in the storage system, a write command and a read command may possibly be transmitted from the multiple higher-level apparatuses to each node at various times. The application of the technology according to the first embodiment allows the high reading performance to be realized even in such a situation. The first embodiment has been described above.

### Second Embodiment

A second embodiment will now be described.

[2-1. Storage System]

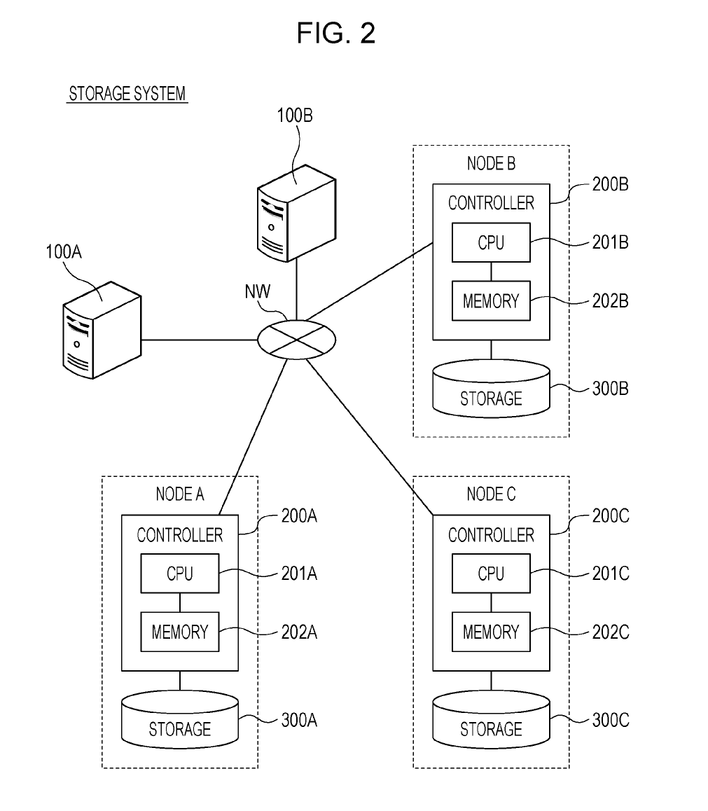

A storage system according to the second embodiment will now be described with reference to FIG. 2. FIG. 2 illustrates an exemplary storage system according to the second embodiment.

The storage system illustrated in FIG. 2 includes host computers 100A and 100B and nodes A, B, and C. The node A includes a controller 200A and a storage 300A. Similarly, the node B includes a controller 200B and a storage 300B and the node C includes a controller 200C and a storage 300C.

The host computers 100A and 100B are examples of the higher-level apparatus. The controllers 200A, 200B, and 200C are examples of the storage control apparatus. The storages 300A, 300B, and 300C are examples of the storage apparatus.

In the following description, the host computers 100A and 100B may be denoted by a host computer 100 without discriminating between the host computers 100A and 100B. Similarly, the controllers 200A, 200B, and 200C may be denoted by a controller 200 without discriminating between the controllers 200A, 200B, and 200C. The storages 300A, 300B, and 300C may be denoted by a storage 300 without discriminating between the storages 300A, 300B, and 300C.

The host computers 100A and 100B are capable of communicating with the controllers 200A, 200B, and 200C via a network NW. The network NW is, for example, a local area network (LAN) or an optical communication network.

The controller 200A includes a CPU 201A and a memory 202A. Similarly, the controller 200B includes a CPU 201B and a memory 202B and the controller 200C includes a CPU 201C and a memory 202C. Use of a processor, such as a DSP, or an electronic circuit, such as an ASIC or an FPGA, instead of each of the CPUs 201A, 201B, and 201C also allows the functions of the controllers 200A, 200B, and 200C to be realized. The CPUs 201A, 201B, and 201C are examples of the control unit.

Each of the memories 202A, 202B, and 202C is a volatile storage unit, such as a RAM, or a non-volatile storage unit, such as an HDD or a flash memory. Each of the memories 202A, 202B, and 202C may be a collection of storage units in which one or more volatile storage units and one or more non-volatile storage units are combined. For example, each of the memories 202A, 202B, and 202C may include a volatile storage unit used as a main storage area, a non-volatile storage unit used as a temporary storage area that temporarily stores data, and a volatile storage unit used as a cache memory.

Each of the storages 300A, 300B, and 300C is, for example, a storage unit including one or more HDDs or SSDs or a storage unit, such as a RAID apparatus or a NAS apparatus. Processing of data (the writing process and reading process) in the storage 300A is controlled by the controller 200A. Similarly, processing of data (the writing process and reading process) in the storage 300B is controlled by the controller 200B. Processing of data (the writing process and reading process) in the storage 300C is controlled by the controller 200C.

Although the example is illustrated in FIG. 2 which one pair of the controller 200 and the storage 300 is included in one node, the nodes may be set in another mode. For example, two or more controllers 200 may be included in one node. Two or more storages 300 may be included in one node.

Although the controller 200 and the storage 300 compose a unit of hardware in each node in the example in FIG. 2, the nodes may be set in another mode. For example, the nodes may be set in units of one or more logical storage areas that are set in the storage unit in the storage 300 or may be set in units of one or more logical arithmetic resources that are set in the processor in the controller 200. In addition, when a technology to virtualize the hardware is applied to operate two or more controllers 200 as three or more virtual controllers, the nodes may be set in units of the virtual controllers. Similarly, virtualization of the storage 300 may be available.

However, the description is presented based on the storage system in FIG. 2 for simplicity. The storage system has been described above.

[2-2. Hardware]

Hardware of the host computer 100, the controller 200, and the storage 300 will now be described.

(Host Computer)

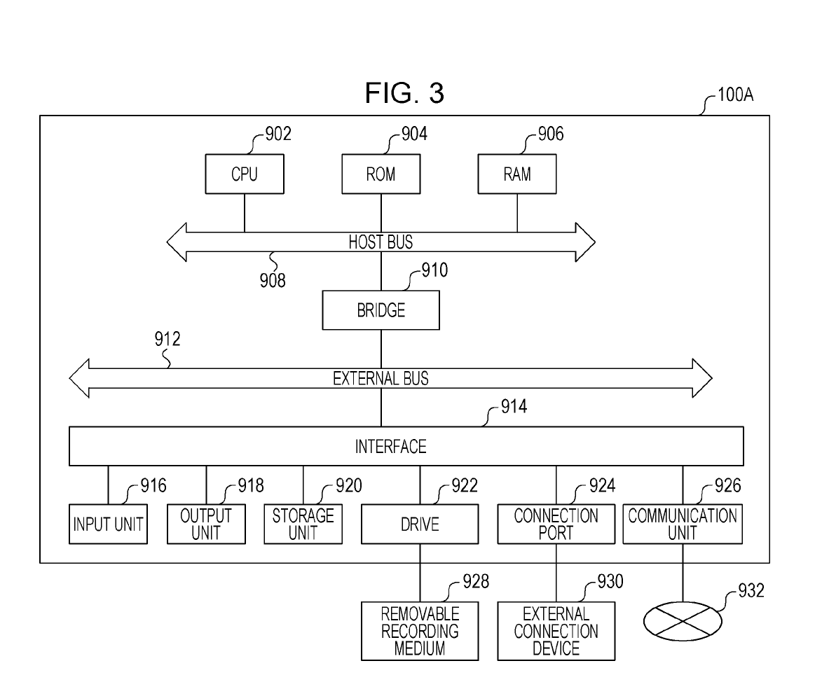

Hardware capable of realizing the function of the host computer 100 will now be described with reference to FIG. 3. FIG. 3 illustrates exemplary hardware capable of realizing the function of the host computer according to the second embodiment.

The function of the host computer 100 is capable of being realized using, for example, the hardware resources in an information processing apparatus illustrated in FIG. 3. In other words, the function of the host computer 100 is realized by controlling the hardware illustrated in FIG. 3 using a computer program.

Referring to FIG. 3, the hardware mainly includes a CPU 902, a read only memory (ROM) 904, a RAM 906, a host bus 908, and a bridge 910. In addition, the hardware includes an external bus 912, an interface 914, an input unit 916, an output unit 918, a storage unit 920, a drive 922, a connection port 924, and a communication unit 926.

The CPU 902 functions as, for example, an arithmetic processing unit or a control unit. The CPU 902 controls the entire operation or part of the operation of each component based on various programs stored in the ROM 904, the RAM 906, the storage unit 920, or a removable recording medium 928. The ROM 904 is an exemplary storage unit that stores, for example, the programs to be read into the CPU 902 and data used in calculation. For example, the programs to be read into the programs and various parameters that are varied in execution of the programs are temporarily or permanently stored in the RAM 906.

These components are connected to each other, for example, via the host bus 908 capable of high-speed data transmission. The host bus 908 is connected to the external bus 912 having a relatively low data transmission speed, for example, via the bridge 910. For example, a mouse, a keyboard, a touch panel, a touch pad, a button, a switch, or a lever is used as the input unit 916. In addition, a remote controller capable of transmitting control signals using infrared rays or other radio waves may be used as the input unit 916.

A display unit, such as a cathode ray tube (CRT), a liquid crystal display (LCD), a plasma display panel (PDP), or an electro luminescence display (ELD), is used as the output unit 918. In addition, an audio output unit, such as a speaker or a headphone, or a printer may be used as the output unit 918. In other words, the output unit 918 is a unit capable of visually or audibly outputting information.

The storage unit 920 is a unit that stores a variety of data. For example, a magnetic storage device, such as an HDD, is used as the storage unit 920. In addition, a semiconductor storage device, such as an SSD or a RAM disk, an optical storage device, or a magneto-optical storage device may be used as the storage unit 920.

The drive 922 is a unit that reads out information recorded in the removable recording medium 928 or writes information into the removable recording medium 928. For example, a magnetic disk, an optical disk, a magneto-optical disk, or a semiconductor memory is used as the removable recording medium 928.

The connection port 924 is, for example, a universal serial bus (USB) port, an IEEE1394 port, a small computer system interface (SCSI) port, an RS-232C port, or an optical audio terminal, which is used to connect the host computer 100A to an external connection device 930. For example, a printer is used as the external connection device 930.

The communication unit 926 is a communication device that connects the host computer 100A to a network 932. For example, a wired or wireless LAN communication circuit, a wireless USB (WUSB) communication circuit, a communication circuit or a router for optical communication, an asymmetric digital subscriber line (ADSL) communication circuit or router, or a mobile phone network communication circuit is used as the communication unit 926. The network 932 connected to the communication unit 926 is a wired or wireless network. The network 932 is, for example, the Internet, a LAN, a broadcasting network, or a satellite communication channel.

(Controller and Storage)

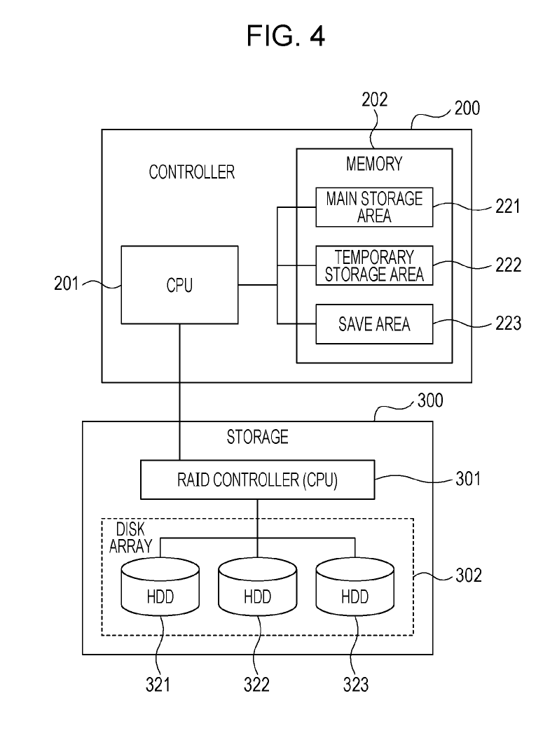

Hardware capable of realizing the functions of the controller 200 and the storage 300 will now be described with reference to FIG. 4. FIG. 4 illustrates exemplary hardware capable of realizing the functions of the controller and the storage according to the second embodiment.

Referring to FIG. 4, the controller 200 includes a CPU 201 and a memory 202. Two or more CPUs 201 may be installed in the controller 200. The CPU 201 in which multiple arithmetic cores are installed may be used. Instead of the CPU 201, for example, a DSP, an ASIC, or an FPGA may be used.

The memory 202 includes a main storage area 221, a temporary storage area 222, and a save area 223. The main storage area 221 is, for example, a volatile storage unit capable of reading out data and writing data at high speed or a storage area set in the volatile storage unit. The temporary storage area 222 is, for example, a non-volatile storage unit, such as a non-volatile RAM (NVRAM), or a storage area set in the non-volatile storage unit. The save area 223 is a volatile storage unit capable of being used as a cache memory or a non-volatile storage unit. Since the save area 223 desirably has a relatively high capacity, a volatile storage unit, such as a dynamic RAM (DRAM), which is relatively inexpensive and has a relatively high processing speed may be used.

The main storage area 221 in the controller 200A is sometimes referred to as a main storage area 221A, the main storage area 221 in the controller 200B is sometimes referred to as a main storage area 221B, and the main storage area 221 in the controller 200C is sometimes referred to as a main storage area 221C in the following description. Similarly, the temporary storage area 222 in the controller 200A is sometimes referred to as a temporary storage area 222A, the temporary storage area 222 in the controller 200B is sometimes referred to as a temporary storage area 222B, and the temporary storage area 222 in the controller 200C is sometimes referred to as a temporary storage area 222C. The save area 223 in the controller 200A is sometimes referred to as a save area 223A, the save area 223 in the controller 200B is sometimes referred to as a save area 223B, and the save area 223 in the controller 200C is sometimes referred to as a save area 223C.

The storage 300 includes an RAID controller 301 and a disk array 302. The disk array 302 includes HDD 321, 322, and 323. The RAID controller 301 performs, for example, management of physical volumes removable from the disk array 302 and management of logical volumes set in the disk array 302. In addition, the RAID controller 301 performs a process of writing data into the disk array 302 and a process of reading out data from the disk array 302 under the control of the controller 200. The hardware has been described above.

[2-3. Use of Save Area]

A writing process and a reading process using the save area will now be described.

(Writing Process)

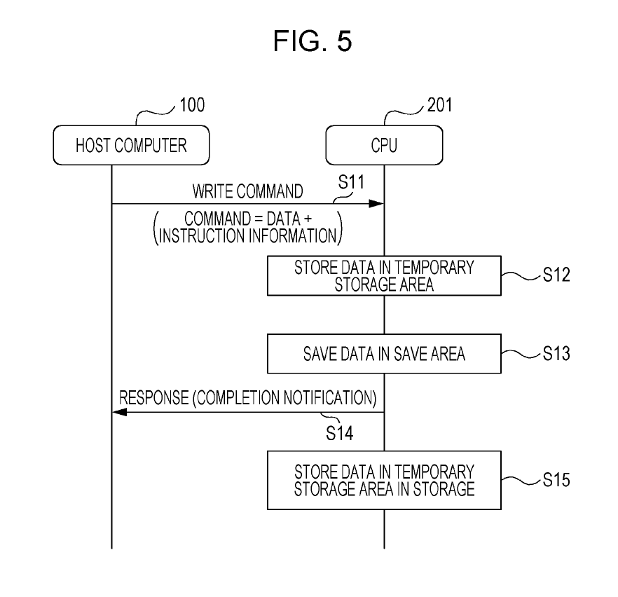

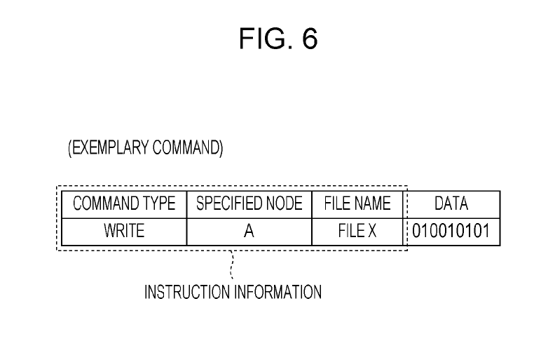

The writing process using the save area will now be described with reference to FIG. 5 and FIG. 6. FIG. 5 is a sequence diagram illustrating an exemplary process performed by the controller in response to the write command. FIG. 6 illustrates an exemplary command.

Referring to FIG. 5, in Step S11, the host computer 100 transmits the write command to the CPU 201 in the controller 200. The write command includes target data and instruction information indicating the content of processing that is instructed.

For example, the command includes a command type, a specified node, a file name, and data, as illustrated in FIG. 6. The command type is information indicating whether the command is the write command or the read command. The specified node is information identifying a node where the instructed processing is to be performed. The file name is information identifying data to be subjected to the instructed processing. The data is a data body to be subjected to the instructed processing. A set of the command type, the specified node, and the file name is called instruction information.

The command illustrated in FIG. 6 has a command type “Write”, a specified node “A”, a file name “File X”, and data “010010101”. This command is the write command instructing the node A to write the data “010010101” identified as the “file X”. However, the read command does not include the data and includes the instruction information including the command type identifying “Read”, the specified node, and the file name to be read out.

Since the example in FIG. 5 illustrates the writing process, the write command including the data and the instruction information is transmitted from the host computer 100 to the CPU 201 in Step S11. In addition, it is assumed in the example in FIG. 5 that the write command instructing the writing process with the node including the controller 200 specified is transmitted from the host computer 100.

Referring back to FIG. 5, in Step S12, the CPU 201 stores the write command received in Step S11 in the temporary storage area 222.

In Step S13, the CPU 201 saves the data stored in the temporary storage area 222 in Step S12 in the save area 223. The saving of the data in the save area 223 allows the CPU 201 to read out the data from the save area 223 even after the data stored in the temporary storage area 222 is deleted.

In Step S14, the CPU 201 transmits the completion notification indicating that the processing in response to the write command is completed to the host computer 100 as a response to the write command received in Step S11. The CPU 201 transmits the completion notification to the host computer 100 immediately after the saving of the data in the save area 223 is completed.

In Step S15, the CPU 201 stores the data in the temporary storage area 222 in the storage 300. The process of storing the data in the storage 300 may be performed at arbitrary timing after the response to the host computer 100 is completed. In other words, the response timing may be asynchronous with the storing timing of the data in the storage 300. For example, Step S15 is performed during a period when the load is low depending on the load status of the CPU 201 or the storage 300. After Step S15, the process illustrated in FIG. 5 is terminated.

(Reading Process)

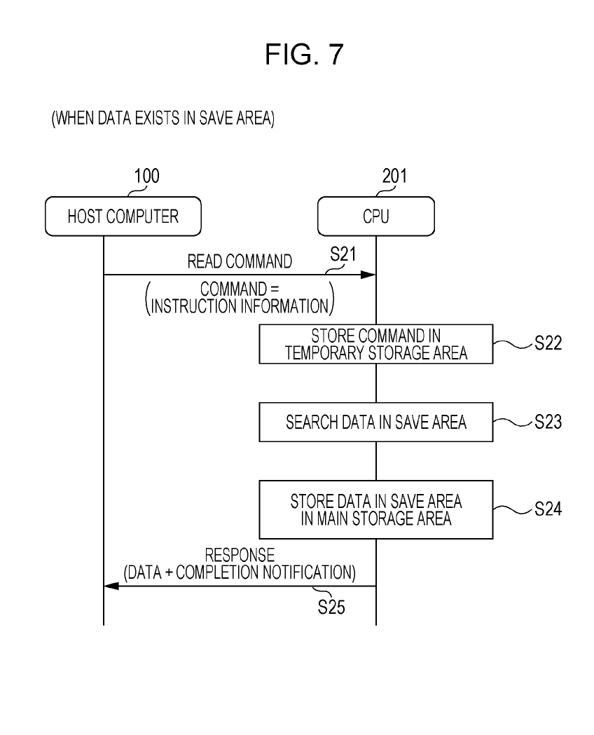

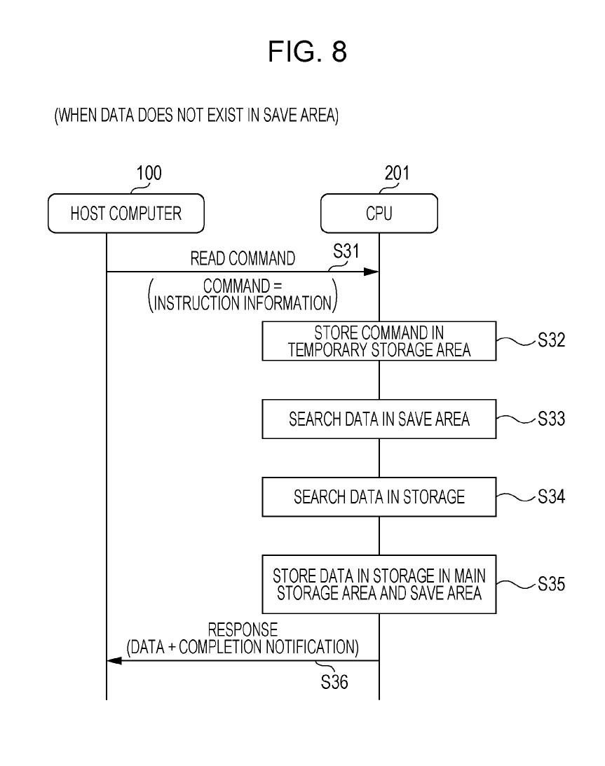

The reading process using the save area will now be described with reference to FIG. 7 and FIG. 8. FIG. 7 is a sequence diagram illustrating an exemplary process (when data exists in the save area) performed by the controller in response to the read command. FIG. 8 is a sequence diagram illustrating an exemplary process (when data does not exist in the save area) performed by the controller in response to the read command.

(When Data Exists in Save Area)

The example in FIG. 7 illustrates the process when data exists in the save area. Referring to FIG. 7, in Step S21, the host computer 100 transmits the read command to the CPU 201 in the controller 200. The read command includes the instruction information. For example, the read command includes information indicating a command type “Read”, the specified node “A”, and the file name “File X”.

In Step S22, the CPU 201 stores the read command received in Step S21 in the temporary storage area 222.

In Step S23, the CPU 201 extracts a file name identifying data to be read out with reference to the instruction information included in the read command stored in the temporary storage area 222. Then, the CPU 201 searches the data stored in the save area 223 for the data having the extracted file name. It is assumed in the example in FIG. 7 that the data having the extracted file name is stored in the save area 223 and the data has been identified by the CPU 201.

In Step S24, the CPU 201 stores the data identified in Step S23 in the main storage area 221.

In Step S25, the CPU 201 transmits the data stored in the main storage area 221 in Step S24 and the completion notification indicating that the processing in response to the read command is completed to the host computer 100 as a response to the read command. After Step S25, the process illustrated in FIG. 7 is terminated.

(When Data Does Not Exist in Save Area)

The example in FIG. 8 illustrates the process when data does not exist in the save area.

Referring to FIG. 8, in Step S31, the host computer 100 transmits the read command to the CPU 201 in the controller 200. The read command includes the instruction information. For example, the read command includes information indicating the command type “Read”, the specified node “A”, and the file name “File X”.

In Step S32, the CPU 201 stores the read command received in Step S31 in the temporary storage area 222.

In Step S33, the CPU 201 extracts a file name identifying data to be read out with reference to the instruction information included in the read command stored in the temporary storage area 222. Then, the CPU 201 searches the data stored in the save area 223 for the data having the extracted file name. It is assumed in the example in FIG. 8 that the data having the extracted file name is not stored in the save area 223 and the data has not been identified by the CPU 201.

In Step S34, the CPU 201 searches the data stored in the storage 300 for the data having the file name extracted in Step S33. It is assumed in the example in FIG. 8 that the data having the extracted file name is stored in the storage 300 and the data has been identified by the CPU 201.

In Step S35, the CPU 201 stores the data identified in Step S34 in the main storage area 221 and the save area 223. Since the data to be read out will possibly be read out in the near future again, the CPU 201 stores the data read out from the storage 300 also in the save area 223 to allow the data to be quickly read out.

In Step S36, the CPU 201 transmits the data stored in the main storage area 221 in Step S35 and the completion notification indicating that the processing in response to the read command is completed to the host computer 100 as a response to the read command. After Step S36, the process illustrated in FIG. 8 is terminated.

The processes using the save area have been described above. As described above, the use of the save area allows the process of reading out data from the storage to be omitted and enables the response using the data read out from the save area when the data is stored in the save area. As a result, it is possible to speed up the response to the host computer.

[2-4. Transfer of Command]

A writing process and a reading process involved in transfer of a command will now be described.

In the case of a single node or when a command is directly transmitted to a target node, the process of writing data and the process of reading out data are capable of being realized in accordance with the examples in FIG. 7 and FIG. 8. However, in a storage system including multiple nodes, a command may be transmitted to a node other than the target node. In this case, the node which has received the command transfers the command to the target command. The processes involved in the transfer of the command will now be described. The two nodes A and B are set as the target nodes for simplicity.

(Writing Process)

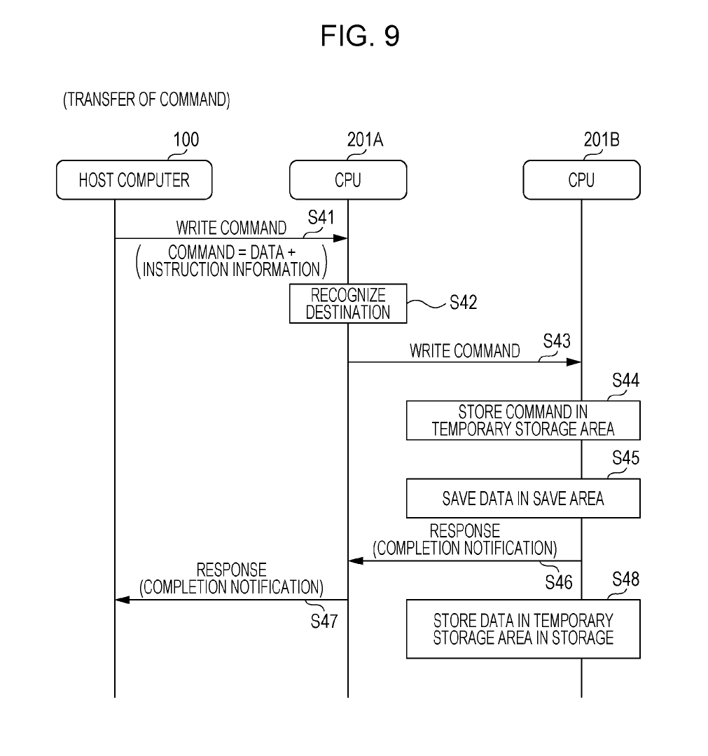

The writing process involved in the transfer of a command will now be described with reference to FIG. 9. FIG. 9 is a sequence diagram illustrating an exemplary process (a process including the transfer of a command) performed by the controller in response to the write command.

Referring to FIG. 9, in Step S41, the host computer 100 transmits the write command to the CPU 201A in the controller 200A belonging to the node A. The write command includes the target data and the instruction information. It is assumed that the write command includes the instruction information indicating the command type “Write”, a specified node “B”, and the file name “File X”.

In Step S42, the CPU 201A analyzes the instruction information included in the write command to recognize the controller in the node, which is the destination of the write command. In the example in FIG. 9, the controller 200B belonging to the node B is recognized as the destination by the CPU 201A.

In Step S43, the CPU 201A transfers the write command to the CPU 201B in the controller 200B.

In Step S44, the CPU 201B stores the write command in the temporary storage area 222B.

In Step S45, the CPU 201B saves the data stored in the temporary storage area 222B in Step S44 in the save area 223B. The saving of the data in the save area 223B allows the CPU 201B to read out the data from the save area 223B even after the writing data stored in the temporary storage area 222B is deleted.

In Step S46, the CPU 201B transmits the completion notification indicating that the processing in response to the write command is completed to the CPU 201A as a response to the write command. The CPU 201B transmits the completion notification to the CPU 201A immediately after the saving of the data in the save area 223B is completed.

In Step S47, the CPU 201A transmits the completion notification indicating that the processing in response to the write command is completed to the host computer 100 as a response to the write command received in Step S41.

In Step S48, the CPU 201B stores the data in the temporary storage area 222B in the storage 300B. Since contention with the reading process of another piece of data may possibly occur in the save area 223B, the data in the temporary storage area 222B is stored in the storage 300B. Then, the write command stored in the temporary storage area 222B (including the writing data) is deleted.

The process of storing the data in the storage 300B may be performed at arbitrary timing after the response to the CPU 201A is completed. In other words, the response timing may be asynchronous with the storing timing of the data in the storage 300B. For example, Step S48 is performed during a period when the load is low depending on the load status of the CPU 201B or the storage 300B. After Step S48, the process illustrated in FIG. 9 is terminated.

(Reading Process)

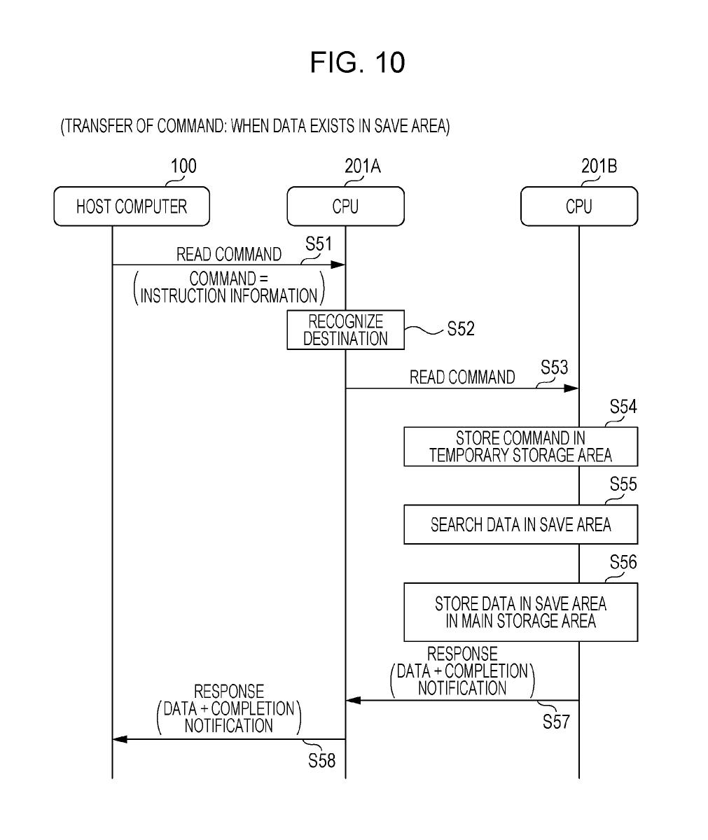

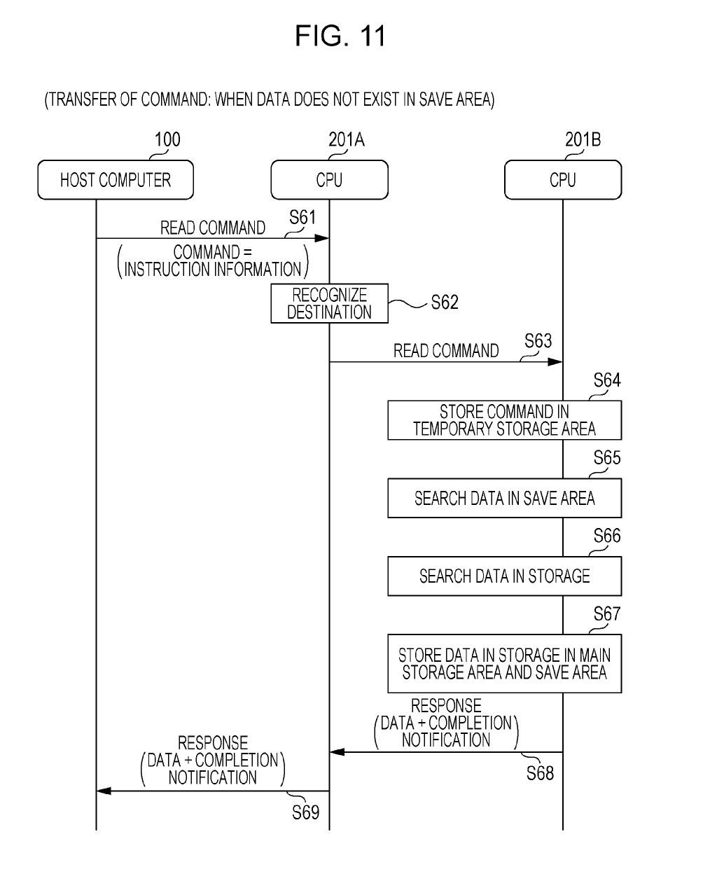

The reading process involved in the transfer of a command will now be described. FIG. 10 is a sequence diagram illustrating an exemplary process (a process including the transfer of a command: when data exists in the save area) performed by the controller in response to the read command. FIG. 11 is a sequence diagram illustrating an exemplary process (a process including the transfer of a command: when data does not exist in the save area) performed by the controller in response to the read command.

(When Data Exists in Save Area)

The example in FIG. 10 illustrates the process when data exists in the save area.

Referring to FIG. 10, in Step S51, the host computer 100 transmits the read command to the CPU 201A in the controller 200A belonging to the node A. The read command includes the instruction information. For example, the read command includes information indicating the command type “Read”, the specified node “B”, and the file name “File X”.

In Step S52, the CPU 201A analyzes the instruction information included in the read command to recognize the controller in the node, which is the destination of the read command. In the example in FIG. 10, the controller 200B belonging to the node B is recognized as the destination by the CPU 201A.

In Step S53, the CPU 201A transfers the read command to the CPU 201B in the controller 200B.

In Step S54, the CPU 201B stores the read command in the temporary storage area 222B.

In Step S55, the CPU 201B extracts a file name identifying data to be read out with reference to the instruction information included in the read command stored in the temporary storage area 222B. Then, the CPU 201B searches the data stored in the save area 223B for the data having the extracted file name. It is assumed in the example in FIG. 10 that the data having the extracted file name is stored in the save area 223B and the data has been identified by the CPU 20B1.

In Step S56, the CPU 201B stores the data identified in Step S55 in the main storage area 221B.

In Step S57, the CPU 201B transmits the data stored in the main storage area 221B in Step S56 and the completion notification indicating that the processing in response to the read command is completed to the CPU 201A in the controller 200A as a response to the read command.

In Step S58, the CPU 201A transmits the data received from the CPU 201B and the completion notification indicating that the processing in response to the read command is completed to the host computer 100 as a response to the read command. After Step S58, the process illustrated in FIG. 10 is terminated.

(When Data Does Not Exist in Save Area)

The example in FIG. 11 illustrates the process when data does not exist in the save area.

Referring to FIG. 11, in Step S61, the host computer 100 transmits the read command to the CPU 201A in the controller 200A belonging to the node A. The read command includes the instruction information. For example, the read command includes information indicating the command type “Read”, the specified node “B”, and the file name “File X”.

In Step S62, the CPU 201A analyzes the instruction information included in the read command to recognize the controller in the node, which is the destination of the read command. In the example in FIG. 11, the controller 200B belonging to the node B is recognized as the destination by the CPU 201A.

In Step S63, the CPU 201A transfers the read command to the CPU 201B in the controller 200B.

In Step S64, the CPU 201B stores the read command in the temporary storage area 222B.

In Step S65, the CPU 201B extracts a file name identifying data to be read out with reference to the instruction information included in the read command stored in the temporary storage area 222B. Then, the CPU 201B searches the data stored in the save area 223B for the data having the extracted file name. It is assumed in the example in FIG. 11 that the data having the extracted file name is not stored in the save area 223B and the data has not been identified by the CPU 201B.

In Step S66, the CPU 201B searches the data stored in the storage 300B for the data having the file name extracted in Step S65. It is assumed in the example in FIG. 11 that the data having the extracted file name is stored in the storage 300B and the data has been identified by the CPU 201B.

In Step S67, the CPU 201B stores the data identified in Step S66 in the main storage area 221B and the save area 223B. Since the data to be read out will possibly be read out in the near future again, the CPU 201B stores the data read out from the storage 300B also in the save area 223B to allow the data to be quickly read out.

In Step S68, the CPU 201B transmits the data stored in the main storage area 221B in Step S67 and the completion notification indicating that the processing in response to the read command is completed to the CPU 201A in the controller 200A as a response to the read command.

In Step S69, the CPU 201A transmits the data received from the CPU 201B and the completion notification indicating that the processing in response to the read command is completed to the host computer 100 as a response to the read command. After Step S69, the process illustrated in FIG. 11 is terminated.

The processes involved in the transfer of the commands have been described above. As described above, the process is caused in which the node which has received the command (the node A in the examples in FIG. 9 to FIG. 11) analyzes the command in the transfer of the command to recognize the destination. Omission of this process allows the command to be more quickly transferred. In addition, not only the transfer of the command but also the use of the command by the node A allows the more efficient process to be realized. A method of speeding up the transfer of a command and a method of increasing the efficiency of the process will now be described.

[2-5. Transfer to All-Nodes Method]

A method (hereinafter referred to as a transfer to all-nodes method) will now be described in which the controller in a node which has received a command transfers the command to the controllers in all the other nodes. The following description is presented in consideration of the three nodes A, B, and C.

(Transfer Method)

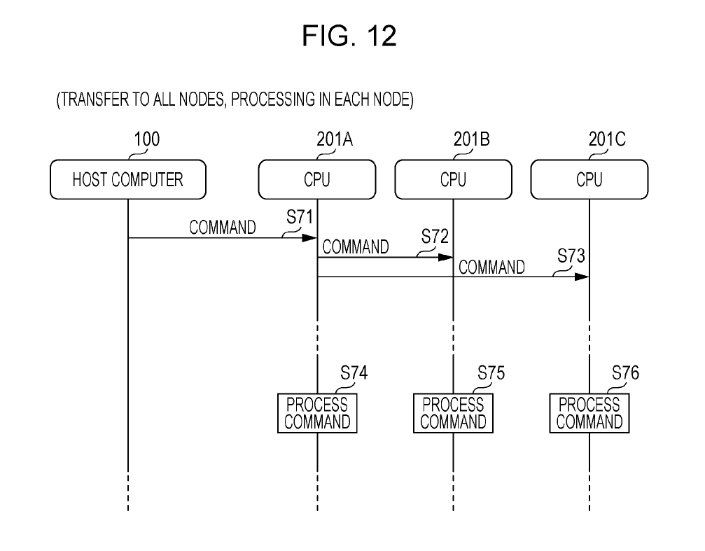

A process of transferring a command involved in the transfer to all-nodes method will now be described with reference to FIG. 12. FIG. 12 is a sequence diagram illustrating an exemplary process performed by the controller according to the second embodiment in response to a command. It is assumed in the example in FIG. 12 that the controller 200A in the node A is selected as the controller (node controller) in the node which receives the command. The node controller notifies the host computer 100 of an error when the node controller has received the command specifying a node other than the node managed by the node controller.

Referring to FIG. 12, in Step S71, the host computer 100 transmits a command to the CPU 201A in the controller 200A belonging to the node A. In Step S72 and Step S73, upon reception of the command, the CPU 201A does not analyze the command and transfers the command to the controllers (the controllers 200B and 200C) belonging to all the other nodes.

In Step S74, the CPU 201A performs processing in response to the command after the transfer of the command. In Step S75, the CPU 201B, which has received the command from the CPU 201A, performs processing in response to the command. In Step S76, the CPU 201C, which has received the command from the CPU 201A, performs processing in response to the command. Upon completion of the processing and completion of a response to the host computer 100, the process illustrated in FIG. 12 is terminated.

As described above, the transfer of the command received from the host computer to all the other nodes allows the process of analyzing the command to select the destination of the transfer to be omitted. In other words, the unconditional transfer of the command to all the other nodes skips the analyzing process in the transfer to speed up the transfer process. As a result, it is possible to reduce the time until the process to be performed after the transfer is started since the command has been received.

(Management Information)

With the transfer to all-nodes method, all the nodes are capable of holding the command, as described above. In addition, all the nodes are capable of performing the process in response to the command. Accordingly, management of the status of performance of the process in response to the command and the status of storage of the data at which the command is targeted expects an increase in the efficiency of the processes in response to subsequent commands. Exemplary management information used to manage the status of performance of the process and the status of storage of the data and methods of updating the management information will now be described.

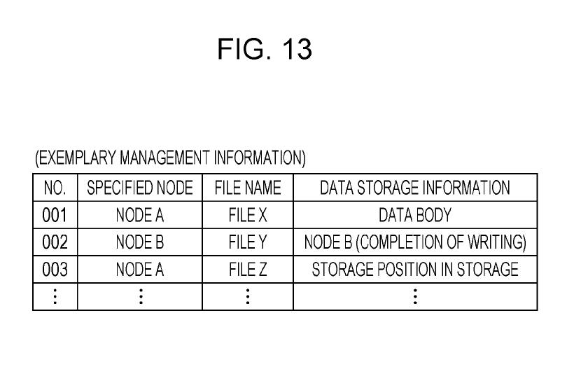

The management information will now be described with reference to FIG. 13 to FIG. 17.

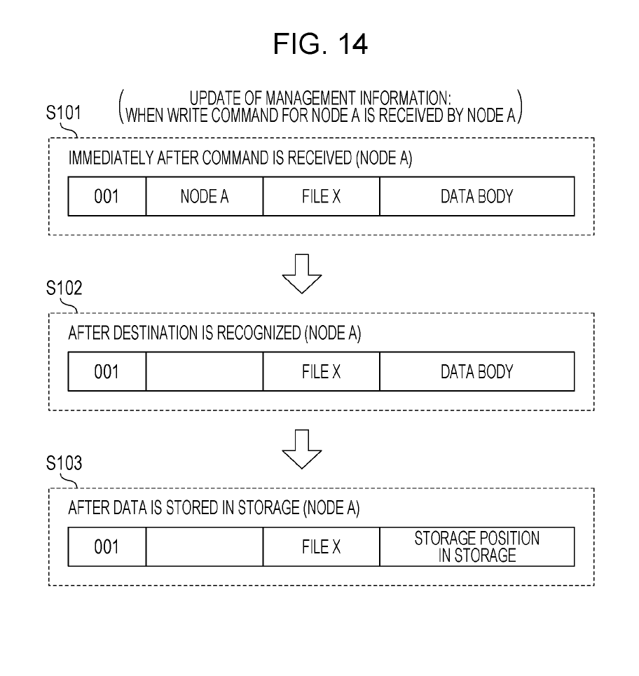

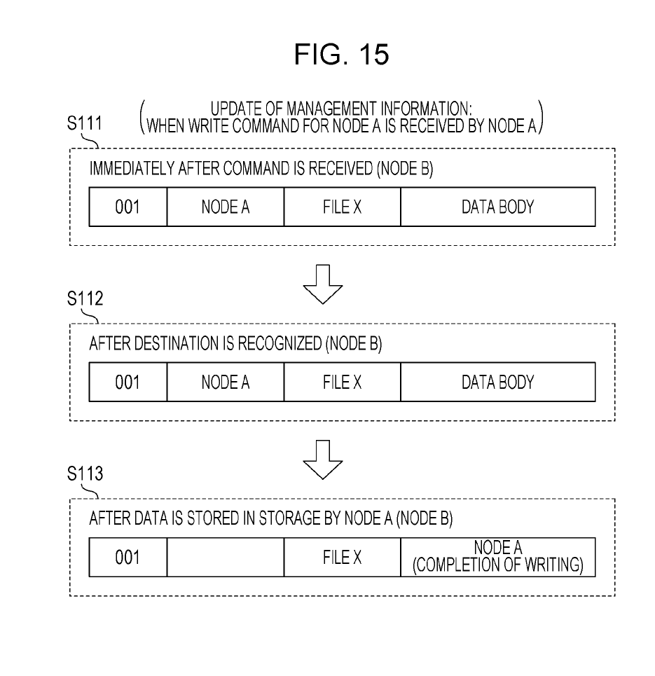

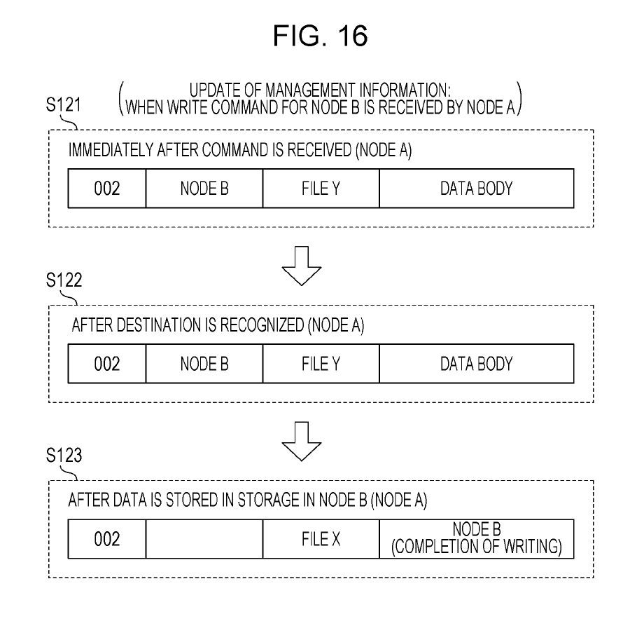

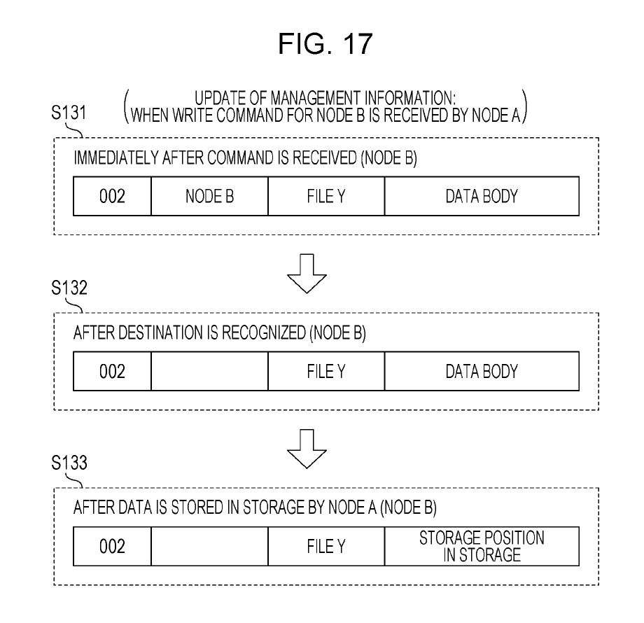

FIG. 13 illustrates an example of the management information according to the second embodiment. FIG. 14 is a first diagram for describing an exemplary method of updating the management information according to the second embodiment. FIG. 15 is a second diagram for describing an exemplary method of updating the management information according to the second embodiment. FIG. 16 is a third diagram for describing an exemplary method of updating the management information according to the second embodiment. FIG. 17 is a fourth diagram for describing an exemplary method of updating the management information according to the second embodiment.

FIG. 13 illustrates an example of the management information held by the controller 200A belonging to the node A. This management information is stored in, for example, the temporary storage area 222A. As illustrated in FIG. 13, the management information includes an identification number (No.) identifying each node, a specified node identifying the node at which the command is targeted, a file name identifying the data at which the command is targeted, and data storage information identifying the storage location and the status of the data at which the command is targeted.

For example, a specified node “Node A”, a file name “File X”, and data storage information “Data body” are described in a record No. 001. This record indicates that the data identified by File X is stored in the save area 223A in response to the command specifying Node A as the node where the processing is performed. The data storage information “Data body” indicates that the data body is stored in the save area 223A.

A specified node “Node B”, a file name “File Y”, and data storage information “Node B (completion of writing)” are described in a record No. 002. This record indicates that the data identified by File Y has been written into the storage 300B belonging to the node B in response to the command specifying Node B as the node where the processing is performed. The data storage information “ Node B (completion of writing)” indicates that the data has been written into the storage 300B in the node B.

The specified node “Node A”, a file name “File Z”, and data storage information “Storage position in storage” are described in a record No. 003. This record indicates that the data identified by File Z is stored in the storage 300A in response to the command specifying Node A as the node where the processing is performed. The data storage information “ Storage position in storage” is information about an address or a pointer identifying the storage position of the data in the storage 300A.

The method of updating the management information will now be described.

(When Write Command for Node A is Received by Node A #1)

The example in FIG. 14 illustrates the process of updating the management information, performed by the controller 200A in the node A when the write command for the node A is received by the node A. The process of updating the management information is manly performed by the CPU 201A. The process of updating the record No. 001 illustrated in FIG. 13 is described here.

Referring to FIG. 14, in Step S101, the CPU 201A extracts the information described as the specified node, the file name, and the data storage information from the write command. Then, the CPU 201A describes the specified node, the file name, and the data storage information in the record in the management information, as illustrated in FIG. 14. After receiving the write command, the CPU 201A saves the data from the temporary storage area 222A to the save area 223A and responds to the host computer 100. Accordingly, the data storage information is “Data body”.

In Step S102, the CPU 201A analyzes the write command to recognize the destination of the write command. Since “Node A” is the destination in the example in FIG. 14, the CPU 201A set the specified node to “blank”.

In Step S103, the CPU 201A stores the data stored in the temporary storage area 222A in the storage 300A after responding to the host computer 100. After storing the data in the storage 300A, the CPU 201A rewrites the data storage information with the information identifying the position in the storage 300 where the data is stored. After Step S103, the process illustrated in FIG. 14 is terminated.

(When Write Command for Node A is Received by Node A #2)

The example in FIG. 15 illustrates the process of updating the management information, performed by the controller 200B in the node B when the write command for the node A is received by the node A. The process of updating the management information is manly performed by the CPU 201B.

Referring to FIG. 15, in Step S111, the CPU 201B extracts the information described as the specified node, the file name, and the data storage information from the write command. Then, the CPU 201B describes the specified node, the file name, and the data storage information in the record in the management information, as illustrated in FIG. 15. After receiving the write command, the CPU 201B saves the data from the temporary storage area 222B to the save area 223B and responds to the host computer 100. Accordingly, the data storage information is “Data body”.

In Step S112, the CPU 201B analyzes the write command to recognize the destination of the write command. Since “Node A” is the destination in the example in FIG. 15, the CPU 201B keeps the specified node to “Node A”.

In Step S113, the CPU 201A in the controller 200A stores the data stored in the temporary storage area 222A in the storage 300A after responding to the host computer 100. After storing the data in the storage 300A, the CPU 201A notifies the CPU 201B of storage completion indicating that the storage of the data is completed. Upon reception of the storage completion, the CPU 201B rewrites the data storage information with “Node A (completion of writing)”. In addition, the CPU 201B sets the specified node to “blank”. After Step S113, the process illustrated in FIG. 15 is terminated.

(When Write Command for Node B is Received by Node A #1)

The example in FIG. 16 illustrates the process of updating the management information, performed by the controller 200A in the node A when the write command for the node B is received by the node A. The process of updating the management information is manly performed by the CPU 201A.

Referring to FIG. 16, in Step S121, the CPU 201A extracts the information described as the specified node, the file name, and the data storage information from the write command. Then, the CPU 201A describes the specified node, the file name, and the data storage information in the record in the management information, as illustrated in FIG. 16. After receiving the write command, the CPU 201A saves the data from the temporary storage area 222A to the save area 223A and responds to the host computer 100. Accordingly, the data storage information is “Data body”.

In Step S122, the CPU 201A analyzes the write command to recognize the destination of the write command. Since “Node B” is the destination in the example in FIG. 16, the CPU 201A keeps the specified node to “Node B”.

In Step S123, the CPU 201B in the controller 200B stores the data stored in the temporary storage area 222B in the storage 300B. After storing the data in the storage 300B, the CPU 201B notifies the CPU 201A of the storage completion indicating that the storage of the data is completed. Upon reception of the storage completion, the CPU 201A rewrites the data storage information with “Node B (completion of writing)”. In addition, the CPU 201A sets the specified node to “blank”. After Step S123, the process illustrated in FIG. 16 is terminated.

(When Write Command for Node B is Received by Node A #2)

The example in FIG. 17 illustrates the process of updating the management information, performed by the controller 200B in the node B when the write command for the node B is received by the node A. The process of updating the management information is manly performed by the CPU 201B.

Referring to FIG. 17, in Step S131, the CPU 201B extracts the information described as the specified node, the file name, and the data storage information from the write command. Then, the CPU 201B describes the specified node, the file name, and the data storage information in the record in the management information, as illustrated in FIG. 17. After receiving the write command, the CPU 201B saves the data from the temporary storage area 222B to the save area 223B and responds to the CPU 201A. Accordingly, the data storage information is “Data body”.

In Step S132, the CPU 201B analyzes the write command to recognize the destination of the write command. Since “Node B” is the destination in the example in FIG. 17, the CPU 201B set the specified node to “blank”.

In Step S133, the CPU 201B stores the data stored in the temporary storage area 222B in the storage 300B after responding to the CPU 201A in the controller 200A. After storing the data in the storage 300B, the CPU 201B rewrites the data storage information with the information identifying the position in the storage 300B where the data is stored. After Step S133, the process illustrated in FIG. 17 is terminated.

As described above, the use of the management information enables the management of the states of the data stored in the storage in the own node and the data stored in the storage in the other node in response to the command received by the own node. Accordingly, when the read command is received from the host computer, it is possible to efficiently perform the responding process using the management information.

(Writing Process)

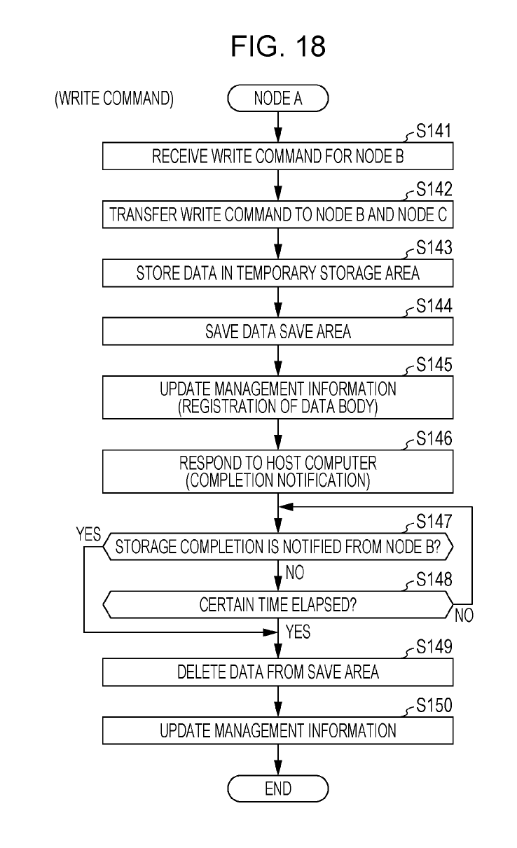

The writing process involved in the transfer to all-nodes method will now be described with reference to FIG. 18 to FIG. 20.

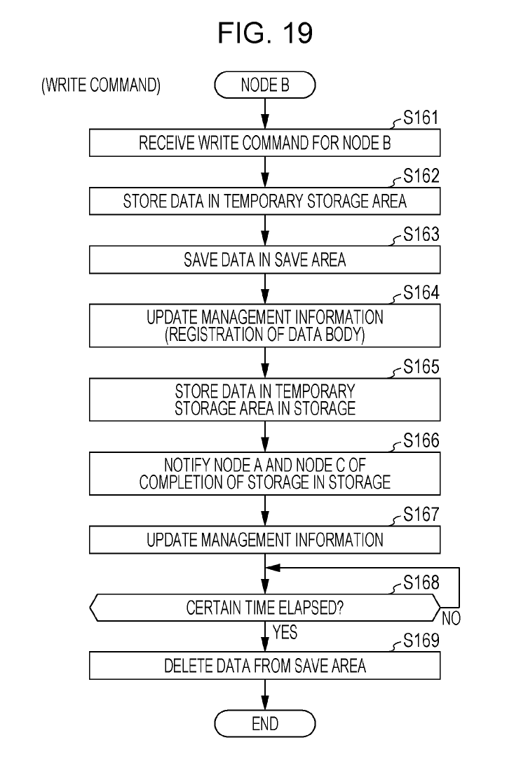

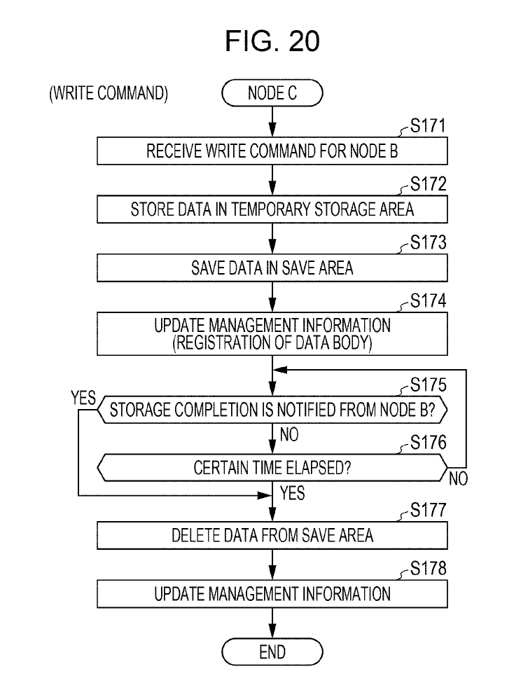

FIG. 18 is a flowchart illustrating an exemplary process performed by the controller in the node A according to the second embodiment in response to the write command. FIG. 19 is a flowchart illustrating an exemplary process performed by the controller in the node B according to the second embodiment in response to the write command. FIG. 20 is a flowchart illustrating an exemplary process performed by the controller in the node C according to the second embodiment in response to the write command.

(Processing in Node A)

The example in FIG. 18 illustrates the process performed when the controller 200A in the node A receives the write command for the node B from the host computer 100. The process illustrated in FIG. 18 is mainly performed by the CPU 201A.

Referring to FIG. 18, in Step S141, the CPU 201A receives the write command for the node B from the host computer 100.

In Step S142, the CPU 201A transfers the write command received in Step S141 to the controller 200B belonging to the node B and the controller 200C belonging to the node C. In other words, the CPU 201A omits the process of recognizing the destination of the write command and transfers the write command to the controllers (the controllers 200B and 200C) belonging to all the nodes.

In Step S143, the CPU 201A extracts the data from the write command and stores the extracted data in the temporary storage area 222A.

In Step S144, the CPU 201A saves the data stored in the temporary storage area 222A in Step S143 in the save area 223A. The saving of the data in the save area 223A allows the CPU 201A to read out the data from the save area 223A even after the data stored in the temporary storage area 222A is deleted.

In Step S145, the CPU 201A extracts the information described as the specified node, the file name, and the data storage information from the write command. Then, the CPU 201A describes the specified node, the file name, and the data storage information in the record in the management information. Since the data is saved in the save area 223A in Step S144, the data storage information is “Data body”.

In Step S146, the CPU 201A transmits the completion notification indicating that the processing in response to the write command is completed to the host computer 100 as a response to the write command.

In Step S147, the CPU 201A determines whether the storage completion is notified from the CPU 201B in the controller 200B belonging to the node B. The storage completion is indicated to the CPUs 201A and 201C after the CPU 201B stores the data in the storage 300B. If the storage completion is notified from the CPU 201B, the process goes to Step S149. If the storage completion is not notified from the CPU 201B, the process goes to Step S148.

In Step S148, the CPU 201A determines whether a certain time elapsed since the data has been saved in the save area 223A. The certain time is set in advance. For example, the certain time may be set in various units, such as 30 seconds, five minutes, 30 minutes, one hour, one day, or one week. If the certain time elapsed, the process goes to Step S149. If the certain time does not elapse, the process goes back to Step S147.

In Step S149, the CPU 201A deletes the data saved in Step S144 from the save area 223A. The deletion of the data saved for a time longer than the certain time from the save area 223A allows the capacity of the save area 223A to be effectively used. In addition, holding the data in the save area 223A for the certain time allows the CPU 201A to quickly respond to the read command specifying the data during the certain time.

In Step S150, the CPU 201A updates the management information. For example, if the storage completion is notified from the CPU 201B, the CPU 201A rewrites the data storage information with “Node B (completion of writing)” and sets the specified node to “blank” (refer to FIG. 16). If the certain elapsed without the storage completion from the CPU 201B, the CPU 201A rewrites the data storage information with, for example, “Node B (non-completion of writing)”. After Step S150, the process illustrated in FIG. 18 is terminated.

(Processing in Node B)

The example in FIG. 19 illustrates the process performed when the controller 200B in the node B receives the write command for the node B from the controller 200A in the node A. The process illustrated in FIG. 19 is mainly performed by the CPU 201B.

Referring to FIG. 19, in Step S161, the CPU 201B receives the write command for the node B from the CPU 201A in the controller 200A belonging to the node A.

In Step S162, the CPU 201B extracts the data from the write command and stores the extracted data in the temporary storage area 222B.

In Step S163, the CPU 201B saves the data stored in the temporary storage area 222B in Step S162 in the save area 223B. The saving of the data in the save area 223B allows the CPU 201B to read out the data from the save area 223B even after the data stored in the temporary storage area 222B is deleted.

In Step S164, the CPU 201B extracts the information described as the specified node, the file name, and the data storage information from the write command. Then, the CPU 201B describes the specified node, the file name, and the data storage information in the record in the management information. Since the data is saved in the save area 223B in Step S163, the data storage information is “Data body”.

In Step S165, the CPU 201B stores the data in the temporary storage area 222B in the storage 300B. The storage of the data in the storage 300B may be performed at arbitrary timing. For example, Step S165 is performed during a period when the load is low depending on the load status in the CPU 201B or the storage 300B.

In Step S166, the CPU 201B notifies the CPU 201A in the controller 200A belonging to the node A and the CPU 201C in the controller 200C belonging to the node C of the storage completion indicating that the storage of the data in the storage 300B is completed. In other words, the CPU 201B notifies the controllers belonging to all the other nodes of the storage completion.

In Step S167, the CPU 201B rewrites the data storage information with the information identifying the position in the storage 300B where the data is stored to update the management information.

In Step S168, the CPU 201B determines whether a certain time elapsed since the data has been saved in the save area 223B. The certain time is set in advance. For example, the certain time may be set in various units, such as 30 seconds, five minutes, 30 minutes, one hour, one day, or one week. If the certain time elapsed, the process goes to Step S169. If the certain time does not elapse, the process goes back to Step S168.

In Step S169, the CPU 201B deletes the data saved in Step S163 from the save area 223B. The deletion of the data saved for a time longer than the certain time from the save area 223B allows the capacity of the save area 223B to be effectively used. In addition, holding the data in the save area 223B for the certain time allows the CPU 201B to quickly respond to the read command specifying the data during the certain time. After Step S169, the process illustrated in FIG. 19 is terminated.

(Processing in Node C)

The example in FIG. 20 illustrates the process performed when the controller 200C in the node C receives the write command for the node B from the controller 200A in the node A. The process illustrated in FIG. 20 is mainly performed by the CPU 201C.

Referring to FIG. 20, in Step S171, the CPU 201C receives the write command for the node B from the CPU 201A in the controller 200A belonging to the node A.

In Step S172, the CPU 201C extracts the data from the write command and stores the extracted data in the temporary storage area 222C.

In Step S173, the CPU 201C saves the data stored in the temporary storage area 222C in Step S172 in the save area 223C. The saving of the data in the save area 223C allows the CPU 201C to read out the data from the save area 223C even after the data stored in the temporary storage area 222C is deleted.

In Step S174, the CPU 201C extracts the information described as the specified node, the file name, and the data storage information from the write command. Then, the CPU 201C describes the specified node, the file name, and the data storage information in the record in the management information. Since the data is saved in the save area 223C in Step S173, the data storage information is “Data body”.

In Step S175, the CPU 201C determines whether the storage completion is notified from the CPU 201B in the controller 200B belonging to the node B. The storage completion is indicated to the CPUs 201A and 201C after the CPU 201B stores the data in the storage 300B. If the storage completion is notified from the CPU 201B, the process goes to Step S177. If the storage completion is not notified from the CPU 201B, the process goes to Step S176.

In Step S176, the CPU 201C determines whether a certain time elapsed since the data has been saved in the save area 223C. The certain time is set in advance. For example, the certain time may be set in various units, such as 30 seconds, five minutes, 30 minutes, one hour, one day, or one week. If the certain time elapsed, the process goes to Step S177. If the certain time does not elapse, the process goes back to Step S175.

In Step S177, the CPU 201C deletes the data saved in Step S173 from the save area 223C. The deletion of the data saved for a time longer than the certain time from the save area 223C allows the capacity of the save area 223C to be effectively used. In addition, holding the data in the save area 223C for the certain time allows the CPU 201C to quickly respond to the read command specifying the data during the certain time.

In Step S178, the CPU 201C updates the management information. For example, if the storage completion is notified from the CPU 201B, the CPU 201C rewrites the data storage information with “Node B (completion of writing)” and sets the specified node to “blank”. If the certain elapsed without the storage completion from the CPU 201B, the CPU 201C rewrites the data storage information with, for example, “Node B (non-completion of writing)”. After Step S178, the process illustrated in FIG. 20 is terminated.

(Reading Process)

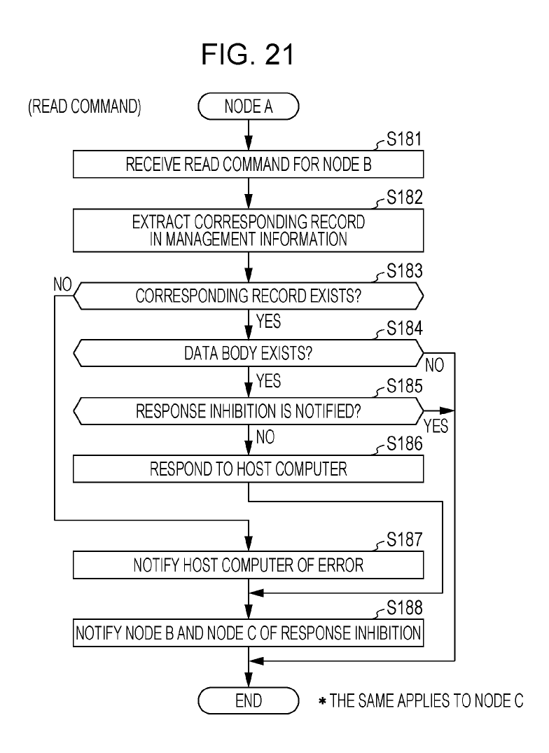

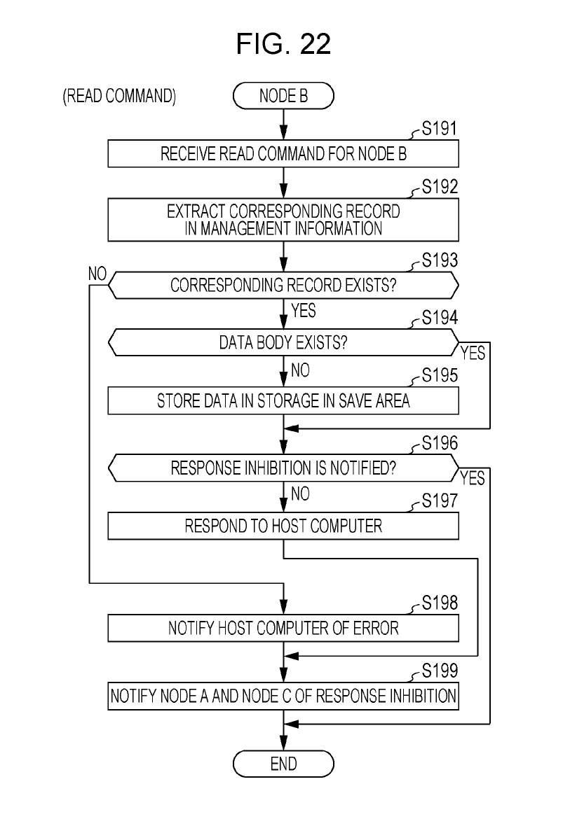

The reading process involved in the transfer to all-nodes method will now be described with reference to FIG. 21 and FIG. 22.

(Processing in Nodes A and C)

FIG. 21 is a flowchart illustrating an exemplary process performed by the controller in the node A according to the second embodiment in response to the read command. FIG. 22 is a flowchart illustrating an exemplary process performed by the controller in the node B according to the second embodiment in response to the read command.

The example in FIG. 21 illustrates the process performed when the controller 200A in the node A receives the read command for the node B from the host computer 100. The process illustrated in FIG. 21 is mainly performed by the CPU 201A.

Referring to FIG. 21, in Step S181, the CPU 201A receives the read command for the node B from the host computer 100.

In Step S182, the CPU 201A identifies the file name from the read command received in Step S181 and extracts the record corresponding to the identified file name from the management information.

In Step S183, the CPU 201A determines whether the corresponding record exists. Specifically, the CPU 201A determines whether the corresponding record has been extracted in Step S182. If the corresponding record exists, the process goes to Step S184. If the corresponding record does not exist, the process goes to Step S187.

In Step S184, the CPU 201A determines whether the data exists in the save area 223A with reference to the data storage information about the record extracted in Step S182. Specifically, the CPU 201A determines whether the data storage information is “Data body”. If the data exists in the save area 223A, the process goes to Step S185. If the data does not exist in the save area 223A, the process illustrated in FIG. 21 is terminated.

In Step S185, the CPU 201A determines whether response inhibition is notified from another node (the node B or C). If the response inhibition is notified, the process illustrated in FIG. 21 is terminated. If the response inhibition is not notified, the process goes to Step S186.

The response inhibition is used to avoid a duplicated response when the controller in another node (the node B or C) has responded to the host computer 100. For example, if the controller 200B belonging to the node B has responded to the host computer 100, the controller 200B notifies the controllers 200A and 200C in the nodes A and C, respectively, of the response inhibition.

In Step S186, the CPU 201A reads out the data from the save area 223A and stores the data that is read out in the main storage area 221A. Then, the CPU 201A transmits the data stored in the main storage area 221A and the completion notification indicating that the processing in response to the read command is completed to the host computer 100 as a response to the read command. After Step S186, the process goes to Step S188.

In Step S187, the CPU 201A notifies the host computer 100 of an error as a response to the read command. For example, the CPU 201A notifies the host computer 100 of an error indicating that the data specified in the read command is stored in no node. After Step S187, the process goes to Step S188.

In Step S188, the CPU 201A notifies the controller 200B belonging to the node B and the controller 200C belonging to the node C of the response inhibition. The notification of the response inhibition to all the other nodes in the above manner when the response to the read command is completed allows a redundant responding process to be reduced, thereby reducing the processing load of the entire system. After Step S188, the process illustrated in FIG. 21 is terminated.

The same process is performed also when the controller 200C in the node C receives the read command for the node B from the host computer 100. However, when the process is applied to the node C, the destination of the response inhibition in Step S188 is changed to the nodes A and B.

(Processing in Node B)

The example in FIG. 22 illustrates the process performed when the controller 200B in the node B receives the read command for the node B from the controller 200A in the node A. The process illustrated in FIG. 22 is mainly performed by the CPU 201B.

Referring to FIG. 22, in Step S191, the CPU 201B receives the read command for the node B from the CPU 201A in the controller 200A belonging to the node A.

In Step S192, the CPU 201B identifies the file name from the read command received in Step S191 and extracts the record corresponding to the identified file name from the management information.

In Step S193, the CPU 201B determines whether the corresponding record exists. Specifically, the CPU 201B determines whether the corresponding record has been extracted in Step S192. If the corresponding record exists, the process goes to Step S194. If the corresponding record does not exist, the process goes to Step S198.

In Step S194, the CPU 201B determines whether the data exists in the save area 223B with reference to the data storage information about the record extracted in Step S192. Specifically, the CPU 201B determines whether the data storage information is “Data body”. If the data exists in the save area 223B, the process goes to Step S196. If the data does not exist in the save area 223B, the process goes to Step S195.

In Step S195, the CPU 201B acquires the data having the file name identified in Step S192 from the data stored in the storage 300B. The CPU 201B stores the acquired data in the save area 223B. After Step S195, the process goes to Step S196.

In Step S196, the CPU 201B determines whether the response inhibition is notified from another node (the node A or C). If the response inhibition is notified, the process illustrated in FIG. 22 is terminated. If the response inhibition is not notified, the process goes to Step S197.

The response inhibition is used to avoid a duplicated response when the controller in another node (the node A or C) has responded to the host computer 100. For example, if the controller 200A has responded to the host computer 100, the controller 200A notifies the controllers 200B and 200C of the response inhibition.

In Step S197, the CPU 201B reads out the data from the save area 223B and stores the data that is read out in the main storage area 2216. Then, the CPU 201B transmits the data stored in the main storage area 221B and the completion notification indicating that the processing in response to the read command is completed to the host computer 100 as a response to the read command. After Step S197, the process goes to Step S199.

In Step S198, the CPU 201B notifies the host computer 100 of an error as a response to the read command. For example, the CPU 201B notifies the host computer 100 of an error indicating that the data specified in the read command is stored in no node. After Step S198, the process goes to Step S199.

In Step S199, the CPU 201B notifies the controller 200A belonging to the node A and the controller 200C belonging to the node C of the response inhibition. The notification of the response inhibition to all the other nodes in the above manner when the response to the read command is completed allows a redundant responding process to be reduced, thereby reducing the processing load of the entire system. After Step S199, the process illustrated in FIG. 22 is terminated.

The transfer to all-nodes method has been described above. The notification of the completion of the storage in the storage to the other nodes allows each node to recognize the storage status of the data. In addition, the storage status of the data is capable of being managed using the management information. Since each node holds the same data in the save area for a certain time and the command is transferred to all the nodes, an arbitrary controller capable of more quickly responding to the command responds to the read command. As a result, the response speed is increased. Furthermore, since the controller which has responded to the command notifies the other nodes of the response inhibition, it is possible to suppress a redundant response to realize the efficient processing.

As described above, the transfer of the command received by the node A to all the other nodes: the nodes B and C allows the process of analyzing the command in the transfer to select the destination to be omitted. As a result, it is possible to speed up the process of transferring the command. In addition, since the data in the same command is held in the nodes A, B, and C, the controller having a higher response speed is capable of quickly responding to the reading request.

For example, when the reading request is submitted to the controller that is performing the writing process, the response to the host computer by another controller enables the quick response. During the operation of the storage system, the write command and the read command may possibly be transmitted from the multiple host computers to each node at various times. The application of the technology according to the second embodiment allows the high reading performance to be realized even in such a situation. The second embodiment has been described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus in a storage system including a plurality of nodes each including a storage apparatus that stores data and the storage control apparatus that controls processing of the data in the storage apparatus, the storage control apparatus comprising:
a communication unit configured to communicate with a higher-level apparatus that instructs processing of the data in the storage apparatus and with the storage control apparatus included in another node; and
a control unit configured to control the communication unit so that a command is transmitted to the storage control apparatuses included in all the other nodes when the communication unit receives the command from the higher-level apparatus, the command including an instruction about processing of data in the storage apparatus included in an arbitrary node.

2. The storage control apparatus according to claim 1, further comprising:
a storage unit configured to temporarily store data,
wherein the control unit stores a command in the storage unit when the communication unit receives the command from the storage control apparatus included in the other node, the command including an instruction about a process of writing data into the storage apparatus included in an arbitrary node and the data.

3. The storage control apparatus according to claim 2,
wherein, when the communication unit receives a command including an instruction about a process of reading out data in the storage apparatus included in the other node and the data at which the instruction is targeted is stored in the storage unit, the control unit controls the communication unit so that the data is read out from the storage unit and is transmitted to the higher-level apparatus.

4. The storage control apparatus according to claim 2,
wherein, when the communication unit receives a command including an instruction about a process of writing data into the storage apparatus included in the node including the control unit and the data from the higher-level apparatus, the control unit stores the command in the storage unit and the control unit controls the communication unit so that a response to the command is transmitted to the higher-level apparatus, and
wherein the control unit stores the data in the storage apparatus after transmitting the response and the control unit controls the communication unit so that a completion notification indicating that the storage of the data in the storage apparatus is completed is transmitted to the storage control apparatuses included in all the other nodes.

5. The storage control apparatus according to claim 4,
wherein, when the communication unit receives the completion notification indicating that the storage of data in the storage apparatus included in the other node is completed from the storage control apparatus included in the other node, the control unit deletes the same data as the data stored in the storage apparatus from the storage unit.

6. The storage control apparatus according to claim 3,
wherein, when the communication unit receives a command including an instruction about a process of reading out data in the storage apparatus included in an arbitrary node and the control unit controls the communication unit so that the data at which the instruction is targeted is read out from the storage unit and is transmitted to the higher-level apparatus, the control unit controls the communication unit so that an inhibition notification to inhibit a response to the command to the storage control apparatuses included in all the other nodes.

7. A storage system including a plurality of nodes each including a storage apparatus that stores data and a storage control apparatus that controls processing of the data in the storage apparatus,
wherein the storage control apparatus includes
a communication unit that communicates with a higher-level apparatus that instructs processing of the data in the storage apparatus and with the storage control apparatus included in another node; and
a control unit that controls the communication unit so that a command is transmitted to the storage control apparatuses included in all the other nodes when the communication unit receives the command from the higher-level apparatus, the command including an instruction about processing of data in the storage apparatus included in an arbitrary node, and
wherein the storage apparatus includes
a connection unit that connects the storage apparatus to the storage control apparatus;
a recording medium that stores data; and
a processing unit that performs a process of writing data into the recording medium or a process of reading out data from the recording medium under control of the storage control apparatus.

8. A non-transitory computer readable storage medium storing a program that causes a computer operating as a storage control apparatus in a storage system including a plurality of nodes each including a storage apparatus that stores data and the storage control apparatus that controls processing of the data in the storage apparatus to perform:
controlling communication with a higher-level apparatus that instructs processing of the data in the storage apparatus and the storage control apparatus included in another node; and
controlling transmission of a command to the storage control apparatuses included in all the other nodes when the command is received from the higher-level apparatus, the command including an instruction about processing of data in the storage apparatus included in an arbitrary node.
